(19) United States
(12) Patent Application Publication
(10) Pub. No.: US 2008/0167394 A1
(43) Pub. Date: Jul. 10, 2008

(54) Process for the preparation of PIPA polyols for the production of highly elastic flexible polyurethane foams

(75) Inventors: Peter Haas, Haan (DE); Bert Klesczewski, Koln (DE); Sven Meyer-Ahrens, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 12/002,603

(22) Filed: Dec. 18, 2007

(30) Foreign Application Priority Data
Dec. 20, 2006 (DE) 102006060376.1

(51) Int. Cl. C08G 18/08; C08G 18/00; C08L 75/04

(52) U.S. Cl. 521/164; 521/155; 521/170; 528/58; 528/85

(57) ABSTRACT

The present invention relates to PIPA polyols, to a process for the preparation of these PIPA polyols, and to a process for the production of highly elastic flexible polyurethane foams from these PIPA polyols.

### CROSS REFERENCE TO RELATED PATENT APPLICATION

The present patent application claims the right of priority under 35 U.S.C. §119 (a)-(d) of German Patent Application No. 10 2006 060 376.1, filed Dec. 20, 2006.

### BACKGROUND OF THE INVENTION

The present invention relates to PIPA polyols, to a process for the preparation of these PIPA polyols, and to a process for the production of highly elastic flexible polyurethane foams from these PIPA polyols.

For the production of flexible polyurethane (PU) foams of high elasticity, modified long-chain polyols which can be classified into three substance classes are used as polyether polyols:
1. SAN-PE dispersions, which are obtained by grafting of polyethers (PE) with suitable monomers, such as styrene and acrylonitrile;
2. polyurea dispersions (PUD), which are obtained by an addition reaction of isocyanates and diamines in the presence of PE; and
3. polyisocyanate polyaddition (PIPA) polyol dispersions, which are obtained by addition of alkanolamines, such as triethanolamine, and isocyanates in the presence of PE.

The foams produced therefrom with a filler content of 10 wt. % on the polyol side have, at a bulk density of 30 kg/m³, a compressive strength of max. 3.0 kPa, and a filler content of 20 wt. % here leading to compressive strengths of approx. 4 kPa, in accordance with DIN 53577 at 40% compression.

DE-A 198 11 471 describes polyurea dispersions which are obtained from monoamines and a further amine by reaction with isocyanates in a polyether (PE). These polyurea dispersions have a viscosity of 4,300 mPa.s at filler levels of about 9.9 wt. %, and of from 2,100 to 2,800 mPa.s/25° C. at filler levels of about 7.7 wt. %, and lead to foams having a good open-cell structure.

The object of the present invention is therefore to provide a process which makes it possible to provide polyisocyanate polyaddition (PIPA) polyols which have a low viscosity and which are suitable for the production of foams of high elasticity and high hardness at low filler contents.

### SUMMARY OF THE INVENTION

The present invention is directed to polyisocyanate polyaddition polyols (PIPA polyols), to a process for the preparation of polyisocyanate polyaddition polyols (PIPA polyols), and to a process for the preparation of highly elastic flexible polyurethane foams from these PIPA polyols.

The polyisocyanate polyaddition polyols (PIPA polyols) of the present invention comprise the reaction product of (1) one or more polyisocyanates, with (2) one or more secondary amine component having at least one hydroxyl group in the molecule, with the proviso that the secondary amine component excludes diethanolamine and/or aminoethylethanolamine, in the presence of (3) one or more compounds having at least two hydrogen atoms which are reactive towards isocyanate groups and having a molecular weight in the range of from 500 to 10,000, and optionally (4) one or more catalysts.

According to the present invention the secondary amine having at least one hydroxyl group in the molecule and the compound having at least two hydrogen atoms which are reactive towards isocyanates and a molecular weight in the range of from 500 to 10,000 g/mol are different from each other and, therefore, mutually exclusive.

The process for preparing the polyisocyanate polyaddition polyols (PIPA polyols) of the present invention comprises (I) reacting (1) one or more polyisocyanates, with (2) one or more secondary amine component having at least one hydroxyl group in the molecule, with the proviso that the secondary amine component excludes diethanolamine and/or aminoethylethanolamine, in the presence of (3) one or more compounds having at least two hydrogen atoms which are reactive towards isocyanate groups and having a molecular weight in the range of from 500 to 10,000, and optionally (4) one or more catalysts.

In accordance with the present invention, it is preferred that one or more tin compounds are used as (4) the catalyst(s).

It is also preferred in the present invention that the secondary amines which have at least one hydroxyl group in the molecule are selected from the group consisting of diisopropanolamine, methylethanolamine and mixtures thereof.

Also, the present invention relates to a process for the production of elastic flexible polyurethane foams. This process comprises (I) reacting
A) one or more polyisocyanates,
   with
B) one or more polyisocyanate polyaddition polyols in accordance with the present invention,
C) optionally, one or more alkanolamine crosslinking agents which correspond to the general formula:

HₘN[(CH₂—CXH—O)ₙH]₃₋ₘ
wherein:
m represents an integer between 0 to 2,
n represents an integer between 1 to 3, and
X represents a hydrogen atom or a methyl group;
D) optionally, one or more additional compounds having at least two hydrogen atoms which are reactive towards isocyanate groups and having a molecular weight of from 32 to 499 g/mol,
E) water and/or one or more readily volatile organic blowing agents,
F) one or more catalysts for promoting the blowing and crosslinking reactions,
G) one or more stabilizers,
H) optionally, one or more known auxiliary substances and/or additives.

According to the present invention the alkanolamine crosslinking agents C) and the compound having at least two hydrogen atoms which are reactive towards isocyanates and a molecular weight in the range of from 32 to 499 g/mol are different from each other and, therefore, mutually exclusive.

The invention also provides elastic flexible polyurethane foams obtainable by the process according to the invention. These elastic flexible polyurethane foams may be form cushioning materials for furniture and/or mattresses.

After conventional reaction, the PIPA polyols of the present invention lead to polyurethane foams which have a surprisingly high hardness at low filler contents and high elasticities.

### DETAILED DESCRIPTION OF THE INVENTION

Isocyanates which can be employed as the isocyanate component in both the PIPA polyol preparation and in preparation of flexible polyurethane foams from these PIPA polyols are aliphatic, cycloaliphatic, araliphatic, aromatic and heterocyclic polyisocyanates, such as are described e.g. by W, Siefken in Justus Liebigs Annalen der Chemie, 562, page 75-136. These polyisocyanates include, for example, those which correspond to the formula:

Q(NCO)ₙ,
in which
n represents an integer from 2 to 4, preferably 2, and
Q represents an aliphatic hydrocarbon radical having 2 to 18 carbon atoms, preferably 6 to 10 carbon atoms, a cycloaliphatic hydrocarbon radical having 4 to 15 carbon atoms, preferably 5 to 10 carbon atoms, an aromatic hydrocarbon radical having 6 to 15 carbon atoms, preferably 6 to 13 carbon atoms, or an araliphatic hydrocarbon radical having 8 to 15 carbon atoms, preferably 8 to 13 carbon atom.

Examples of suitable polyisocyanates include those which are described in DE-OS 28 32 253, pages 10 to 11, believed to correspond to U.S. Pat. No. 4,263,408, the disclosure of which is hereby incorporated by reference.

As a rule, the polyisocyanates which are readily accessible industrially and are not further modified are particularly preferred for the present invention. For example, these include isocyanates such as 2,4- and 2,6-toluene-diisocyanate and any other desired mixtures of these isomers (“TDI”), and polyphenyl-polymethylene polyisocyanates, such as are prepared by aniline-formaldehyde condensation and subsequent phosgenation (“crude MDI”). Polyisocyanates containing carbodiimide groups, urethane groups, allophanate groups, isocyanurate groups, urea groups or biuret groups (the so-called “modified polyisocyanates”), in particular those modified polyisocyanates which are derived from 2,4- and/or 2,6-toluene-diisocyanate or from 4,4′- and/or 2,4′-diphenylmethane-diisocyanate, can be co-used. However, their presence is not specific to the process.

Secondary amine compounds having at least one hydroxyl group in the molecule are also required for the preparation of the PIPA polyols. Diethanolamine and aminoethylethanolamine are excluded from the suitable secondary amine compounds for the present invention. It is preferred that these secondary amines which have at least one hydroxyl group in the molecule are selected from the group consisting of: N-methylethanolamine, N-methyl-isopropanolamine, N-ethylethanolamine, diisopropanolamine and hydroxyethylisopropanolamine.

Particularly preferred secondary amines which have at least one hydroxyl group in the molecule are monoalkylalkanolamines. As stated above, suitable secondary amines for the present invention exclude diethanolamine and aminoethylethanolamine. As set forth in DE-A 1020050701, the use of diethanolamine and aminoethylethanolamine in preparing PIPA polyols leads to foams with relatively low compressive strengths, i.e. which are 2 kPa at a bulk density of 30 kg/m³.

In accordance with the present invention, the compounds which contain at least two hydrogen atoms which are reactive towards isocyanate groups that are required for the preparation of the PIPA polyols and have a molecular weight in the range of from 500 to 10,000 are typically polyether polyols (i.e. poly(oxyalkylene) polyols) and will typically have a functionality in the range of from 2 to 6. These polyether polyols preferably have a number-average molecular weight in the range from 1,000 to 10,000 g/mol. However, mixtures of such polyols can also be employed.

The poly(oxyalkylene) polyols employed in accordance with the present invention can be prepared, for example, by polyaddition of one or more alkylene oxides on to one or more polyfunctional starter compounds in the presence of basic catalysts. Preferred starter compounds are water and molecules which have from two to six hydroxyl groups per molecule. Some examples of such starter compounds include triethanolamine, 1,2-ethanediol, 1,2-propanediol, 1,3-propanediol, diethylene glycol, dipropylene glycol, triethylene glycol, tripropylene glycol, 1,2-butanediol, 1,3-butanediol, 1,4-butanediol, 1,2-hexanediol, 1,4-hexanediol, 1,5-hexanediol, 1,6-hexanediol, glycerol, trimethylolpropane, pentaerythritol, mannitol or sorbitol.

Suitable alkylene oxides which are preferably used for the preparation of the poly(oxyalkylene) polyols employed herein are oxirane, methyloxirane and ethyloxirane. These can be used by themselves or in mixtures with each other. If used in a mixture, it is possible to react the alkylene oxides randomly or blockwise or both in succession. Further details are to be found in “Ullmanns Encyclopadie der industriellen Chemie”, volume A 21, 1992, page 670 et seq. The polyether polyols typically used in the preparation of the PIPA polyols preferably contain primary OH groups.

Suitable alkanolamine crosslinking agents for the present invention correspond to the general formula:

HₘN[(CH₂—CXH—O)ₙH]₃₋ₘ
in which:
m represents an integer between 0 to 2,
n represents an integer between 1 to 3, and
x represents a hydrogen atom or a methyl group.

Such alkanolamines are optionally employed in the production of the flexible polyurethane foams of the invention.

Compounds such as diisopropanolamine, triisopropanolamine, triethanolamine, diethanolamine, 2-hydroxyethyl-2-hydroxypropylamine and bis(2-hydroxyethoxyethyl)-amine or mixtures therefore are to be understood as particularly preferred crosslinking agents in the preparation of foams.

Suitable compounds having at least two hydrogen atoms which are reactive towards isocyanate groups and have molecular weights of from 32 to 499 g/mol include, for example, compounds that contain hydroxyl groups and/or amino groups and/or thiol groups and/or carboxyl groups. These compounds preferably contain hydroxyl groups and/or amino groups, and serve as chain lengthening agents or crosslinking agents in the foam formulations herein. These compounds as a rule contain from 2 to 8, preferably 2 to 4 hydrogen atoms which are reactive towards isocyanate groups. Examples of these compounds are disclosed in DE-OS 2 832 253, pages 19-20, believed to correspond to U.S. Pat. No. 4,264,408, the disclosure of which is hereby incorporated by reference.

In the production of flexible polyurethane foams, a blowing agent must also typically be present in the foam forming composition. Water is preferably employed as a blowing agent. Water acts as a chemical blowing agent and supplies carbon dioxide as a blowing gas by the reaction of the water with isocyanate groups. Preferably, water is employed in an amount of from 1.0 to 6.0 wt. %, preferably 1.5 to 5.5 wt. %, based on the sum of the amounts of components B)+C)+D). Non-combustible physical blowing agents, such as carbon dioxide, and in particular carbon dioxide in liquid form, can also be used as a suitable blowing agent. In principle, blowing agents are selected from the class of hydrocarbons and include compounds such as, for example, C₃-C₆-alkanes, e.g. butanes, n-pentane, iso-pentane, cyclopentane, hexanes or the like, or halogenated hydrocarbons such as, for example, methylene chloride, dichloromono-fluoromethane, chlorodifluoroethane, 1,1-dichloro-2,2,2-trifluoroethane or 2,2-dichloro-2-fluoroethane, and in particular, chlorine-free fluorohydrocarbons such as, for example, methylene fluoride, trifluoromethane, difluoroethane, 1,1,1,2-tetrafluoroethane, tetrafluoroethane (R 134 or R 134a), 1,1,1,3,3-pentafluoropropane (R 245 fa) 1,1,1,3,3,3-hexafluoropropane (R 256), 1,1,1,3,3-pentafluorobutane (R 365 mfc) or heptafluoropropane or also sulfur hexafluoride, can also be uged. Mixtures of these blowing agents can also be used. The compositions for the production of the flexible polyurethane foams herein also comprise one or more catalysts for the blowing and crosslinking reaction. Suitable catalysts include those of the type known per se such as, for example tertiary amines, such as triethylamine, tributylamine, N-methyl-morpholine, N-ethyl-morpholine, N,N,N′,N′-tetramethylethylenediamine, pentamethyldiethylenetriamine and higher homologues (as described in DE-A 2 624 527 and 2 624 528 which are believed to correspond to GB 1520225 and GB 1530226), 1,4-diazabicyclo-(2,2,2)-octane, N-methyl-N′-dimethylaminoethylpiperazine, bis(dimethylaminoalkyl)-piperazines, N,N-dimethylbenzylamine, N,N-dimethylcyclohexylamine, N,N-diethylbenzylamine, bis-(N,N-diethylaminoethyl) adipate, N,N,N′,N′-tetramethyl-1,3-butanediamine, N,N-dimethyl-p-phenylethylamine, 1,2-dimethylimidazole, 2-methylimidazole, monocyclic and bicyclic amidines and bis(dialkylamino)-alkyl ethers, such as 2,2-bis(dimethylaminoethyl)ether.

Organometallic compounds can also be used suitable catalysts in the preparation of the PIPA polyols herein. A particularly preferred type of organometallic compounds include organotin compounds. Possible organotin compounds are, in addition to sulfur-containing compounds, compounds such as di-n-octyltin mercaptide, and preferably tin(I) salts of carboxylic acids, such as tin(II) acetate, tin(II) octoate, tin(II) ethylhexoate and tin(I) laurate, and the tin(IV) compounds, e.g. dibutyltin oxide, dibutyltin dichloride, dibutyltin diacetate, dibutyltin dilaurate, dibutyltin maleate or dioctyltin diacetate.

Additional examples of auxiliary agents and additives which may optionally be used in accordance with the present the invention include, for example, further additives and foam stabilizers and cell regulators, reaction retardants, stabilizers, flame retardant substances, plasticizers, dyestuffs and fillers and fungistatically and bacteriostatically active substances and details of the method of use and mode of action of these additives are described in Kunststoff-Handbuch, volume VII, published by Vieweg and Höchtlen, Carl Hanser Verlag, Munich 1993, 3rd edition, e.g. on pages 104 to 127.

Stabilizers and further auxiliary substances and additives are also optionally employed in the reaction of the PIPA polyols to yield the flexible polyurethane foams of the invention. Preferred stabilizers which may be mentioned include, for example, polyether-siloxanes, preferably water-insoluble representatives. These compounds are in general built up in a manner in which a short-chain copolymer of ethylene oxide and propylene oxide is bonded to a polydimethylsiloxane radical. Such foam stabilizers are described e.g. in U.S. Pat. Nos. 2,834,748, 2,917,480 and 3,629,308, the disclosures of which are hereby incorporated by reference, and in U.S. Pat. No. 2,917,480, the disclosure of which is hereby incorporated by reference. Auxiliary substances and additives which are used include, for example, tricresyl phosphate, tris(2-chloroethyl)phosphate, tris(2-chloropropyl)phosphate, tris(2,3-dibromopropyl)phosphate, tetrakis(2-chloroethyl)ethylene-diphosphate, dimethyl methane-phosphonate, diethanolaminomethylphosphonic acid diethyl ester, tris(dipropylene glycol)phosphite, tris(dipropylene glycol)phosphate, bis(2-hydroxyethyl)-ethylene glycol diphosphate bis(2-chloroethyl ester) and halogen-containing polyols having a flameproofing action. Further examples of components H) which are optionally to be co-used are cell regulators, reaction retardants, stabilizers against discolorations and oxidation reaction, plasticizers, dyestuffs and fillers and fungistatically and bacteriostatically active substances. These are usually added to the polyol component in amount of from 0 to 10 parts by weight, preferably 2 to 6 parts by weight. Details of the method of use and mode of action of these additives are described in G. Oertel (ed.): “Kunststoff-Handbuch”, volume VII, Carl Hanser Verlag, 3rd edition, Munich 1993, page 110-115.

For production of flexible polyurethane foams, the reaction components are reacted according to the invention by the one-stage process which is known per se or the prepolymer process or semi-prepolymer process, mechanical equipment often being used. Additional details are disclosed in, for example, U.S. Pat. No. 2,764,565, the disclosure of which is hereby incorporated by reference. Details of processing equipment which is also possible according to the invention are described in Kunststoff-Handbuch, volume VII, published by Vieweg and Hochtlen, Carl Hanser Verlag, Munich 1966, e.g. on pages 121 to 205.

The reaction is as a rule carried out in a characteristic isocyanate index range of from 90 to 130.

In the production of foam, in accordance with the invention, the foaming can also be carried out in closed molds. In this context, the reaction mixture is introduced into a mold. Possible mold materials include metals such as, for example, aluminium, or plastic, for example, epoxy resin.

In the mold, the foamable reaction mixture foams and forms the shaped article. In this context, mold foaming can be carried out such that the molding has a cell structure on its surface. However, it can also be carried out such that the moulding acquires a compact skin and a cellular core. In this connection, the procedure according to the invention can be such that foamable reaction mixture is introduced into the mold in an amount such that the foam formed just fills the mold.

However, a procedure can also be followed in which more foamable reaction mixture than is necessary to fill the mold cavity with foam is introduced into the mold. In the latter case, the process is thus carried out with “overcharging”; such a procedure is known and described in, for example, U.S. Pat. Nos. 3,178,490 and 3,1821104, the disclosures of which are hereby incorporated by reference.

“External release agents” which are known per se, such as silicone oils, are often co-used during mold foaming. However, so-called “internal release agents”, optionally in a mixture with external release agents, can also be used, such as have been disclosed e.g. in DE-OS 21 21 670 and 23 07 589, which are believed to correspond to GB Patent 1,365,215 and U.S. Pat. Nos. 4,201,847 and 4,254,228, the disclosures of which are hereby incorporated by reference.

Preferably, however, the foams are produced by slabstock foaming.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

The following compounds and components were used in the working examples described below:

Polyether Polyol A: a polyether polyol having an OH number of 35 and a functionality of three, prepared by the addition of propylene oxide and ethylene oxide in a weight ratio of 82.5 to 17.5 to trimethylolpropane as a starter

Tegostab® B 8681: a foam stabilizer based on polysiloxane-polyether (commercially available from Goldschmidt)

Niax® A1: bis(2-dimethylamino)ethyl ether in dipropylene glycol (commercially available from GE Speciality Chemicals)

Dabco® 33LV: 33% triethylenediamine, 67% dipropylene glycol (commercially available from Air Products)

Desmorapid® SO: tin 2-ethylhexanoate (commercially available from Rheinchemie)

Isocyanate A: mixture of 2,4- and 2,6-TDI (80:20) having an NCO content of 48 wt. %

Isocyanate B: mixture of 2,4- and 2,6-TDI (65:35) having an NCO content of 48 wt. %

DBTDL: dibutyltin dilaurate

Preparation of the PIPA Polyols:

The individual components for the preparation of the PIPA polyols were metered into the reaction vessel via a high pressure mixing head and then left to react.

PIPA Polyol 1:

PIPA Polyol 1 was prepared from (i) 95.33 parts of Polyether Polyol A, (ii) 4.67 parts by wt. of diisopropanolamine, and (iii) 3.06 parts by wt. of Isocyanate B.

After standing overnight, this resulted in a PIPA polyol having the following characteristics:
OH number: 55.9,
viscosity: 2,680 mPa.s/25° C., and
concentration of urea in the dispersion: 7.5 wt. %.

PIPA Polyol 2:

PIPA Polyol 2 was prepared from (i) 95.07 parts by wt. of Polyether Polyol A, (ii) 0.03 part by wt. of dibutyltin dilaurate, (iii) 4.9 parts by wt. of N-methylethanolamine and (iv) 5.67 parts by wt. of Isocyanate B. After standing overnight, this resulted in a PIPA polyol having the following characteristics:
OH number: 57.5,
viscosity: 2,670 mPa.s/25° C.;
concentration of urea in the PIPA polyol: 10.0 wt. %.

### II) FOAMING EXAMPLES

The foams in Examples 1-3 were prepared by the one-stage process using conventional processing techniques for the production of flexible foams:

| Foam Example 1: | Foam 1 | |
|---|---|---|
| PIPA Polyol 1: | 100 | parts by wt. |
| Tegostab ® B 8681: | 0.5 | part by wt. |
| Niax ® A1: | 0.15 | part by wt. |
| Dabco ® 33LV: | 0.1 | part by wt. |
| Desmorapid ® SO: | 0.1 | part by wt. |
| Water: | 3.0 | parts by wt. |
| Isocyanate A: | 10.25 | parts by wt. |
| Isocyanate B: | 30.75 | parts by wt. |
| Isocyanate Index: | 108 | |

Foam 1 had the following properties:
Bulk density: 29 kg/m³
Compressive strength (40% comp.): 3.7 kPa

| Foam Example 2: | Foam 2 | |
|---|---|---|
| PIPA Polyol 2: | 100 | parts by wt. |
| Tegostab ® B 8681: | 0.5 | part by wt. |
| Niax ® A1: | 0.1 | part by wt. |
| DBTDL: | 0.05 | part by wt. |
| Water: | 2.0 | parts by wt. |
| Isocyanate B: | 30.58 | parts by wt. |
| Isocyanate Index: | 108 | |

Foam 2 had the following properties:
Bulk density: 46 kg/m³
Compressive strength (40% comp.): 4.9 kPa
Rebound resilience: 62%

| Foam Example 3: | Foam 3 | |
|---|---|---|
| IPA Polyol 2: | 100 | parts by wt. |
| Tegostab ® B 8681: | 0.3 | part by wt. |
| Niax ® A1: | 0.15 | part by wt. |
| DBTDL: | 0.1 | part by wt. |
| Water: | 3.0 | parts by wt. |
| Isocyanate B: | 41.0 | parts by wt. |
| Isocyanate Index: | 108 | |

Foam 3 had the following properties:
Bulk density: 30.5 kg/m³
Compressive strength (40% comp.): 4.2 kPa
Rebound resilience: 52%

The foams (i.e. Foams—13) which were obtained by foaming the PIPA polyols representative of the present invention show, at low filler contents, a surprisingly high hardness with good elasticity values. Thus, PIPA Polyol 1 with 7.5 % of filler, resulted in a foam having a hardness of 3.7 kPa at a bulk density of 29 kg/m³, while PIPA Polyol 2 with 10% filler, resulted in a foam having a hardness of 4.2 kPa at a bulk density of 30.5 kg/m³ and in a foam having a hardness of 4.9 kPa at a bulk density of 46 kg/m³.

At a comparable filler content of 10% of filler, dispersions based on SAN, PUD or urethane dispersion, typically result in foams having hardnesses of approx. 3.0 kPa at a bulk density of about 30 kg/m³, and in foams having hardnesses of about 4 kPa at a bulk density of about 42 kg/m³ (for SAN or PUD dispersions).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the preparation of polyisocyanate polyaddition polyols (PIPA polyols), comprising reacting (1) one or more polyisocyanates with (2) one or more secondary amine components having at least one hydroxyl group in the molecule, with the proviso that said secondary amine component is not diethanolamine or aminoethylethanolamine, in (3) at least one compound having at least two hydrogen atoms which are reactive towards isocyanate groups and having a molecular weight in the range of from 500 to 10,000 g/mol, and optionally, (4) one or more catalysts.

2. The process of claim 1, wherein (4) said one or more catalysts comprise one or more tin compounds.

3. The process of claim 1, wherein (2) said secondary amine components having at least one hydroxyl group in the molecule is selected from the group consisting of diisopropanolamine and methylethanolamine.

4. A polyisocyanate polyaddition (PIPA) polyol comprising the reaction product of
(1) one or more polyisocyanates,
with
(2) one or more secondary amine components having at least one hydroxyl group in the molecule, with the proviso that said secondary amine component is not diethanoalamine or aminoethylethanolamine,
in the presence of
(3) at least one compound having at least two hydrogen atoms which are reactive towards isocyanate groups and having a molecular weight in the range of from 500 to 10,000,
and, optionally
(4) one or more catalysts.

5. A process for the production of elastic flexible polyurethane foams comprising reacting
A) one or more polyisocyanates;
with
B) the polyisocyanate polyaddition polyols of claim 4;
C) optionally, one or more alkanolamine crosslinking agents which correspond to the general formula:
HₘN[(CH₂—CXH—O)ₙH]₃₋ₘ
wherein:
m represents an integer between 0 to 2
n represents an integer between 1 to 3, and
X denotes hydrogen or a methyl group;
D) optionally, one or more compounds having at least two hydrogen atoms which are reactive towards isocyanate groups and have a molecular weight of from 32 to 499 g/mol;
E) water and/or one or more readily volatile organic blowing agents,
F) one or more catalysts for promoting the blowing and crosslinking reactions;
G) one or more stabilizers; and
H) optionally, one or more auxiliary substances and additives.

6. Elastic flexible polyurethane foams produced by the process of claim 5.

7. Cushioning material for furniture and/or mattresses comprising the elastic flexible polyurethane foam of claim 6.
